(19) United States
(12) Patent Application Publication
(10) Pub. No.: US 2006/0128294 A1
(43) Pub. Date: Jun. 15, 2006

(54) PREPACKAGED READY-TO-EAT PATE-LIKE FOOD PRODUCT

(76) Inventor: HOWARD M. ROME, GLOUCESTER, MA (US)

Correspondence Address: GEORGE A. HERBSTER, 40 BEACH STREET, SUITE 303, MANCHESTER, MA, 01944, US

(21) Appl. No.: 10/905,026

(22) Filed: Dec. 10, 2004

(51) Int. Cl. A22C 11/00

(52) U.S. Cl. 452/34

(57) ABSTRACT

A prepackaged, ready-to-eat food product made by processing food emulsion in a rigid casing. After processing the ends of the tubes are closed by removable stoppers and end caps. For dispensing the product, a consumer removes the end caps and one stopper and forces the other stopper to shift the product through the rigid case and out the one end for being sliced or otherwise removed.

### FIELD OF THE INVENTION

A novel prepackaged ready-to-eat pate-like food product and a method and apparatus for processing edible ingredients to form such a prepackaged ready-to-eat pate-like food product.

### DESCRIPTION OF RELATED ART

Over the years eating habits have changed. There now is a trend toward choosing prepackaged ready-to-eat food products for a variety of purposes, such as for meals, hors d'oeuvres and snacks. In response to this trend, a variety of processes have been developed for forming diverse prepackaged food products.

For example, U.S. Pat. No. 3,342,609 to Bank et al. discloses a container in the form a clear resilient plastic cylindrical shell that is open at either end with a double disk plunger of relatively soft material at a lower end. A confection is disposed in the shell above the upper disk. The shell comprises an inwardly flanged edge at the bottom to abut the lower disk in its lower most position. The opposite end of the shell flares outwardly and provides a flange closure cap. This container receives fluid ice confections, such as ice cream, sherbets, and the like, with the disk in a retracted position. After the confection is frozen, a consumer dispenses the frozen confection by displacing one of the disks through the shell.

U.S. Pat. No. 4,818,545 to Kunimoto discloses a food material-container combination that allows food material to be cooked and solidified without a pot. Specifically, the material-container combination includes a self standing container with an opening at the top. After charging the container with a food material, an upper portion is hand sealed. Then the food is processed to produce a finished product. The container is then cut along a line to remove the end product.

U.S. Pat. No. 4,950,494 to Katoh et al. discloses a process for producing fish-paste products that includes the steps of continuously charging a starting material based on minced fish flesh into a stirring/mixing machine that shears the starting material. The process then forms the minced fish flesh for extrusion into a specific shape and heats the formed minced flesh to produce a fish-paste product having excellent gel strength.

U.S. Pat. No. 6,261,611 to Berman discloses a hand-held food package that enables heterogeneous foods, such as filled pastas, burritos and the like, to be shipped, stored and heated in the same disposable package from which they were extruded for direct consumption. The hand-held food package includes an ovenable tubular container and piston at a receiving end of the container and a food extruding end. A food tube is contained within the tubular container between the piston and the food extruding ends that comprises a rolled sheet of food. A food mass to be heated is inserted into the container formed by the rolled sheet of food. The food can then be heated and the piston moved to dispense the food package including the rolled sheet of food from the container.

U.S. Pat. No. 6,534,111 to Kita discloses frozen sushi ingredients for rolled cores. Flake, chipped or minced raw fish is filled into a plurality of grooved segments in a plate. Everything is then frozen to form and retain a plurality of frozen sushi ingredient bars within the plate. In the frozen state the frozen sushi ingredient bars are used as rolled cores for rolled sushi.

U.S. Pat. No. 6,764,705 to Shefet discloses a casing-less flowable food production method system and associated elongated forming tubes. A quantity of flowable food emulsion is introduced into one forming tube and advanced through the forming tube while exposing the emulsion to predetermined processing conditions that convert the flowable emulsion held in the forming tube to a non-flowable food product having the molded shape of the forming tube cavity.

The foregoing references disclose different food products and packages. However, none of these references discloses a processing method and food product in which the food is prepared in the same package that is shipped to a consumer and the consumer uses to store the food, to dispense portions of the food from the package and to restore unused portions of the food to the same package, especially where the food product has a pate-like consistency.

### SUMMARY

It is an object of this invention to produce a prepackaged, ready-to-eat pate-like food product for consumer use.

Another object of this invention is to produce an edible pate-like product that is manufactured, shipped and stored in a rigid casing for consumer use as a prepackaged, ready-to-eat food product.

Another object of this invention is to provide a method for forming an edible pate-like product for shipment in a rigid casing for consumer use.

Yet another object of this invention is to provide apparatus for producing an edible pate-like product in a rigid casing for consumer use.

In accordance with one aspect of this invention, a prepackaged food product comprises a rigid tube and a stopper at each end of the tube. Each stopper is removable from and movable within the tube. An edible pate-like filling formed from a food emulsion is located in the rigid tube between the stoppers. Removal of one stopper at one end of the tube enables motion of the other stopper within the tube to dispense the edible pate-like filling from the end.

In accordance with another aspect of this invention, a prepackaged ready-to-eat pate like food product is manufactured by preparing a food emulsion. An open ended tube is placed on a base in a vertical orientation and receives a predetermined measure of the food emulsion. The food emulsion is then processed to produce a final product under compression. After the processing is complete the ends of the tubes are sealed with stoppers whereby the compressed food emulsion in the tube constitutes an edible pate-like food.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a perspective view, partially broken away, of a packaged food product incorporating this invention;

FIG. 2 is a perspective view of a packaged food product in accordance with this invention with a portion of the food product being dispensed from a rigid tube;

FIG. 3 is a perspective view of one food processing fixture adapted for batch processing of foods in accordance with this invention;

FIG. 4 is a flow chart that depicts one process by which the food product in FIGS. 1 and 2 is produced.

FIGS. 5A, 5B and 5C are cross-sections of a single tube in the fixture of FIG. 3 that is useful in understanding the process described in FIG. 4.

### DESCRIPTION OF ILLUSTRATIVE EMBODIMENTS

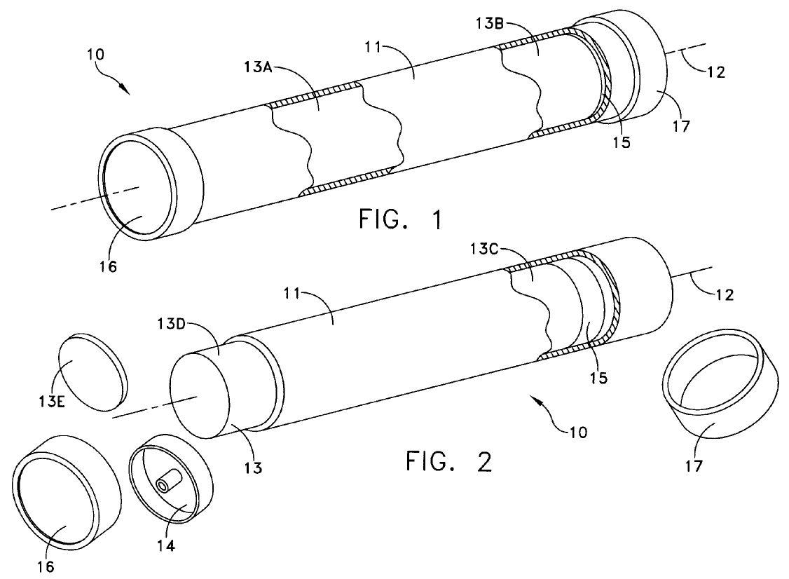

FIG. 1 depicts a prepackaged ready-to-eat food product 10 that incorporates this invention in a form that might be purchased by a consumer. Specifically, prepackaged product 10 includes a rigid casing 111 that extends along an axis 12. The rigid casing 111 can be extruded in any shape or manufactured by methods other than extrusions. Typically the rigid casing 111 will be shaped as a tube formed of a food-compatible material such as a food-compatible polycarbonate that can withstand processing temperatures as described later.

The rigid casing 11 contains a pate-like filling 13 formed from any of a variety of ingredients including, but not limited to fish, shellfish, poultry and meats. That is, the filling 13 has characteristics of a semi solid or viscous gelatinous material whereby a portion of the filling 13 dispensed from the rigid casing 111 retains its shape. As shown by the removed portions of the rigid casing 11, shown for purposes of illustration, portions 13A and 13B are portions of the filling 13 in the rigid casing 11. Stoppers 14 and 15, such as shown in more detail in FIG. 2, are located within the rigid casing 11 and abut the opposite ends of the filling 13. Friction with the rigid casing 11 holds the stoppers 14 and 15 in place. The prepackaged food product may also include end caps 16 and 17 to isolate the food filling 13 further.

Referring to FIG. 2, in use, a consumer removes the end caps 16 and 17 and one of the stoppers, such as the stopper 14. Then the consumer slides the other stopper, in this specific example the stopper 15, axially to the left. This displaces the pate-like filling 13 within the rigid casing 111 due to the semi-solid nature of the filling 13 thereby to move a portion 13D exteriorly of the rigid casing 11. Portions can then be removed for consumption, such as a slice 13E.

The food product 13 undergoes minimal compression and minimal deformation when an axial force is applied against a face due to its semi-solid nature. Consequently if the entirety of the dispensed portion 13D is not consumed, the consumer can place the stopper 14 against the end of the portion 13D and move it to the right in FIG. 1. This displaces the food filling 13 and stopper 15 to the right in FIG. 2 to place the entire contents within the rigid casing 11. The stopper 14 can then be replaced. Next the end caps 16 and 17 can be replaced, if desired, before returning the packaged food product 10 to storage, typically in a refrigerator.

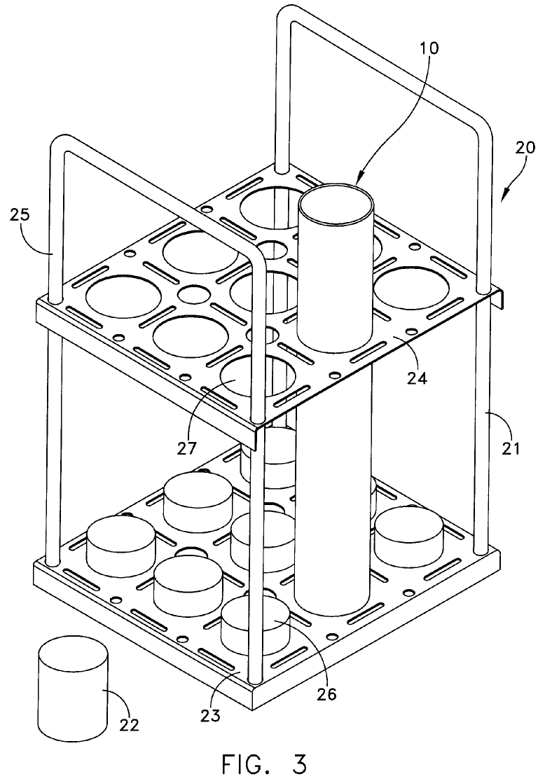

FIG. 3 depicts processing apparatus 20 that is adapted for producing small batches of edible pre-packaged food products in accordance with this invention in small batches. The apparatus comprises three basic elements. The first element is a processing fixture 21 or rack; the second element, a set of rigid casings, such as the rigid casing 11 shown in FIGS. 1 and 2; and the third element, a weight, such as the weight 22, for each rigid casing 11. The weight 22 has a diameter that is slightly less than the inner diameter of a rigid casing 11 so the weight 22 can slide easily in the rigid casing 11.

The processing fixture 21 includes a horizontal spaced parallel floor 23 and upper support 24. A frame 25 forms two handles that extend from the floor 23 past the upper support 24. The floor 23 carries a plurality of cylindrical supports arranged in a matrix, the support 26 being shown by way of example. The cylindrical support 26 has a diameter that is slightly less than the inner diameter of the rigid casing 11.

The upper support 24 includes a plurality of apertures vertically aligned with the cylindrical supports 26. For example, aperture 27 aligns vertically with the cylindrical support 26. In this particular example the cylindrical supports and apertures define a 3×3 matrix for holding nine rigid casings.

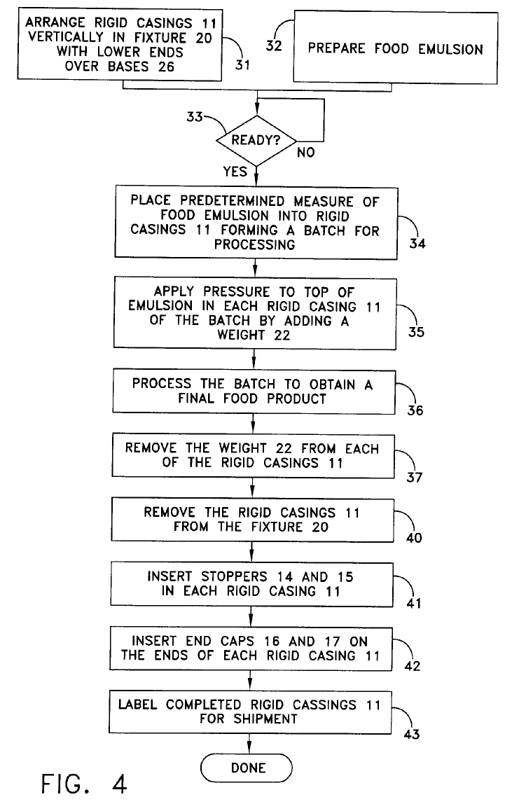

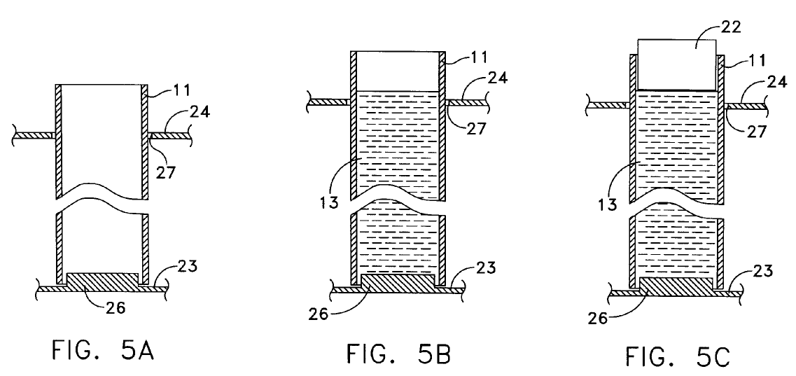

FIG. 4 outlines the process 30 by which a prepackaged food product can be produced in accordance with this invention. Step 31 represents a preparation step of arranging the various rigid casings 11 in the production apparatus, such as is shown in the apparatus 20 of FIG. 3. FIG. 5A depicts this step by presenting a depiction of an empty rigid casing 11 carried about a cylindrical support 26 extending from the floor 23 and stabilized in a vertical position by portions of the upper support 24 adjacent the aperture 27.

Step 32 represents a preparatory step for producing a food emulsion for being loaded into the rigid casings 11. The following three examples indicate the types of processing that can occur in step 32.

### EXAMPLE 1

A shellfish-based, pate-like product is made of tiger shrimp. Raw tiger shrimp is pretreated by salting and then washing in an alcohol-based or other appropriate washing solution, such as a white wine. After washing, the raw tiger shrimp is marinated for about 10 minutes. Typically the marinade has the same composition or ingredients as the washing solution. Next the process continues by comminuting the marinated tiger shrimp, as by pureeing, to produce an uncooked tiger shrimp emulsion.

### EXAMPLE 2

Another pate-like product is made of haddock. Raw haddock is pretreated by salting and then washing in an alcohol-based or other appropriate washing solution. After washing, the haddock continues to marinate for 10 minutes in a marinade, again usually having the same composition or ingredients as the washing solution. Next the process continues by comminuting the marinated haddock, as by pureeing, to produce an uncooked haddock emulsion.

### EXAMPLE 3

A meat-base pate-like product is made of a meat loaf mixture of raw ground beef and vegetables. The mixture is pretreated by salting and then washing in an appropriate washing solution that may include a white wine. After washing, the mixture marinates for 10 minutes in a marinade usually having the same composition or ingredients of the washing solution. Next the process continues by comminuting the mixture, as by pureeing, to produce an uncooked meat loaf emulsion.

This invention is adapted for providing a packaged ready-to-eat food product with a variety of meat, fish, shellfish and poultry ingredients. Each of the foregoing examples uses an alcohol-based marinade, such as a white wine. Other marinades could be substituted with different marinade times. Likewise, each is described using pureeing as a comminuting process. Chopping, grinding, shearing and other comminuting processes known in the art could be substituted for the purpose of producing a food emulsion.

When the rigid casings 11 are arranged in the fixture 21 and a food emulsion has been prepared in step 32, step 33 indicates that the batch processing can begin. The first step, as shown in step 34, is to place a predetermined measure of the prepared food emulsion into each of the rigid casings, such as the rigid casing 11, to form a batch that is represented by up to nine tubes in the specific fixture 21 shown in FIG. 3. This is shown in FIG. 5B.

It has been found that the transformation of the food emulsion, which is a viscous liquid, to a solid or semi-solid pate-like food product is enhanced in the process by applying pressure to the top of the food emulsion 13 in the rigid casings 11. As specified in step 35 and shown in FIG. 5C, in one embodiment pressure is produced by inserting a weight 22 into the top of the rigid casing 111 to lie on top of the food emulsion 13. The rigid casing 111 and the density of the food emulsion prevent the weight 22 from sinking into the food emulsion 13.

Step 36 represents the processing of the batch to obtain a final food product by cooking and pasteurizing the food emulsion. For different ingredients, the process will vary. In each of the foregoing examples, step 36 includes steaming the batch at atmospheric pressure until the food emulsion reaches a temperature of at least 140° F. Pasteurization then occurs by quickly reducing the temperature to less than 40° F. over a period of less than four hours.

As will be apparent, during the processing it is possible for the ingredients to expand. The rigid casing 11 has sufficient hoop strength to contain the ingredients radially within the rigid casing 11. The compression provided by the weight 22 minimizes any axial expansion of the ingredients within the rigid casing 111 that would otherwise occur.

Modified processing steps for steaming and pasteurization could be substituted for use with the foregoing and other food emulsions of other ingredients.

Once the batch processing of step 36 has been completed, step 37 represents the removal of the weight 22 from each of the rigid casings 11. Step 40 represents the removal of the rigid casings 111 from the fixture 20. At this point there is sufficient friction between the food product in the rigid casing 111 to prevent the cooked and pasteurized food from sliding out of the rigid casing 11. Step 41 represents the process of inserting stoppers 14 and 15. The end caps, if desired, are applied in step 42. Step 43 represents the process of labeling the prepackaged food product for shipment and sale to consumers. It may also be desirable to wrap or seal the entire package at the end of the manufacturing cycle.

The end product shown in FIG. 1 typically will be refrigerated for storage. When a consumer wishes to consume some of the product, the end caps 16 and 17 and one of the stoppers, such as the stopper 14 are removed. The other stopper, such as the stopper 15, is displaced along the axis 12. This dispenses the portion 13D of the finished food product that can be readily removed. When it is desired to restore the product, the stopper 14 is placed to abut the end of the dispensed portion 13D. An axial force displaces the stoppers 14 and 15 and the intermediate product 13 back into the rigid casing 11. Then the end caps 16 and 17 can be replaced.

It has been found through testing that the process by which the food materials are cooked and packaged in a rigid casing provides several advantages. For example, the rigid casings are common to both manufacturing and consumer use and are used in transport. This significantly minimizes the packaging and handling issues. In addition, the produce is less susceptible to damage during transport.

As no materials are added during the cooking process of step 36, the process is simplified. Yields are maintained. It has also been found that the flavor of the food product remains constant or even improves over time. The food products have many uses as a topping for hors d'oeuvres, or as an ingredient to be added to salads. In other situations it might be desirable to sauté the food product.

This food product, apparatus for producing the food product and process has been described in terms of a specific embodiment. It will be apparent that many variations of this invention can be implemented. For example, the apparatus shown in FIG. 3 is an apparatus for small batch processing for cooking food in nine rigid casings at a time. Other size matrices might be used. Further, the process is readily adapted from batch processing to continuous processing. Three specific examples of different types of foods have been disclosed. Still others can be used. For example, the described method and apparatus have been used to produce pate-like foods based upon monk fish, goose-fish liver, white shrimp, chicken, meatloaf ingredients, pollack and scallops.

This invention has been disclosed in terms of certain embodiments. Adopting the process particularly in FIG. 3 for such products will be readily apparent to persons of ordinarily skill in the art. Consequently, it will be apparent that many modifications can be made to the disclosed apparatus without departing from the invention. Therefore, it is the intent of the appended claims to cover all such variations and modifications as come within the true spirit and scope of this invention.

What is claimed is:

1. A packaged ready-to-eat food product comprising:
A) a rigid casing,
B) a stopper at each end of said casing, one of said stoppers being removable and the other of said stoppers being movable within said rigid casing, and
C) an edible pate-like filling in said rigid casing between said stoppers whereby motion of the other of said stoppers within the rigid casing dispenses the filling from the end of the rigid casing from which the one stopper has been removed.

2. A packaged ready-to-eat food product as recited in claim 1 wherein said edible filling is a cooked food emulsion.

3. A packaged ready-to-eat food product as recited in claim 2 wherein said edible filling is pasteurized.

4. A packaged ready-to-eat food product as recited in claim 1 wherein said edible filling is pasteurized.

5. A packaged ready-to-eat food product as recited in claim 1 wherein said food emulsion is taken from the group of comminuted meat, fish, shellfish and poultry.

6. A packaged ready-to-eat food product as recited in claim 1 wherein said rigid casing in a food-compatible polycarbonate tube and said stoppers are positioned at opposite ends of said tube adjacent said filling.

7. A packaged ready-to-eat food product as recited in claim 6 additionally comprising an end cap on each end of said tube.

8. A packaged ready-to-eat food product as recited in claim 6 wherein said rigid casing is formed of a food compatible polycarbonate material.

9. A process for manufacturing a packaged ready-to-eat food product comprising the steps of:
A) preparing a food emulsion,
B) inserting an open-ended rigid casing on a base in a vertical orientation,
C) measuring a predetermined quantity of the food emulsion into the rigid casing,
D) processing the food emulsion in the rigid casing,
E) compressing the food emulsion during said processing thereby to minimize expansion of the food emulsion,
F) blocking the ends of the rigid casing after said processing whereby said compressed processed food emulsion in said rigid casing constitutes the packaged ready-to-eat food product.

10. A process for manufacturing a packaged ready-to-eat food product as recited in claim 9 wherein said processing includes cooking the food emulsion during said compression.

11. A process for manufacturing a packaged ready-to-eat food product as recited in claim 9 including pasteurizing the food emulsion during said compression.

12. A process for manufacturing a packaged ready-to-eat food product as recited in claim 9 wherein said processing includes pasteurizing the food emulsion during said compression.

13. A process for manufacturing a packaged ready-to-eat food product as recited in claim 9 wherein the base includes a plurality of cylindrical supports, each support engaging a bottom end of a rigid casing in a vertical position and defining a space therebetween.

14. A process for manufacturing a packaged ready-to-eat food product as recited in claim 13 wherein said rigid casing is a tube and said process includes inserted stoppers into opposite ends of the tube to abut said cooked food emulsion.

15. A process for manufacturing a packaged ready-to-eat food product as recited in claim 14 including the insertion of end caps on each end of the tube.

16. A process for manufacturing a packaged ready-to-eat food product as recited in claim 13 wherein said preparation of said food emulsion includes comminuting a solid food material taken from the group of meats, fish, shellfish and poultry.
